(19) United States
(12) Patent Application Publication
(10) Pub. No.: US 2018/0029945 A1
(43) Pub. Date: Feb. 1, 2018

(54) Solid Granulated Fertilizer Formulated with Mineral Clays, Siderophore Chelating Agents, Secondary Nutrients and Micronutrients

(71) Applicant: José Luis Miranda Valencia, Celaya (MX)

(72) Inventor: José Luis Miranda Valencia, Celaya (MX)

(21) Appl. No.: 15/547,225

(22) PCT Filed: Jan. 29, 2015
(86) PCT No.: PCT/MX2015/000024

§ 371 Date: Jul. 28, 2017

(51) Int. Cl. C05D 3/00

(52) U.S. Cl. CPC C05D 3/00

(57) ABSTRACT

Provided herein is a fertilizing composition including iron, zinc, manganese, boron, copper, molybdenum, sulphur, calcium, magnesium, siderophores and natural clays.

### FIELD OF INVENTION

The present invention relates to a granular solid fertilizer composition comprising as carrier material a mineral clay additioned with secondary nutrients and micronutrients such as calcium, magnesium, sulfur, iron, zinc, manganese, boron, copper and molybdenum; being added in its soluble form to guarantee assimilation by plants, besides the addition of Siderophores, all this for the nutrition of agronomic crops, where the Siderophores are iron chelating agents, able to sequester this one in the presence of other metals and to reduce it of its form Fe³⁺ to Fe²⁺, a much more soluble and usable form for plant nutrition.

### BACKGROUND OF THE INVENTION

In order to obtain the high yields and good quality that are currently expected, the use of fertilizers has become indispensable due to the low fertility of most soils, so making proper use of them is important for sustainable agriculture.

Soils contain all the essential elements that plants requires for its development and reproduction, but in most cases not in sufficient quantities to obtain high yields and good quality, so it is indispensable to add the nutrients by means of fertilizers. Without using fertilizers, yields will be increasingly low due to gradual impoverishment of the soil because of nutrient extraction as a result of agricultural practice. An infertile soil produces less, has less vegetation cover and is more exposed to erosion.

Due to agronomic practice man has realized that proper use of fertilizers results in higher yields. Mineral nutrients are those originated in soil and have been divided into three groups: major nutrients (Nitrogen, Phosphorus and Potassium), secondary ones (Calcium, Magnesium and Sulfur) and the smaller ones (Iron, Zinc, Manganese, Boron, Copper, Molybdenum, and Chlorine). This division is related to the amounts required by plants, but not the importance of the nutrients themself.

As a result of the high levels of extraction by plants, the major nutritional elements are generally the first ones that show deficiency levels in soil; while secondary and minor are required in smaller quantities and their deficiencies are not so obvious, but very important to consider. Although required in small quantities, lack of any of them would limit plant growth even when all other nutrients are in adequate quantities.

The presence of clay in our fertilizer makes it possible to dilute the nutrients and micronutrients at concentrations adequate to be assimilated by plants, whereas the presence of charged components (secondary nutrients, micronutrients, siderophores and clay) results in that the absorption Is performed with adequate efficiency.

The role of each of these nutrients and micronutrients has long been studied, calcium stimulates growth of stems and roots, intervenes in the formation of grains, seeds and fruits, provides resistance to diseases and participates in enzymatic activation. Magnesium favors the absorption of phosphorus, is part of the chlorophyll molecule and the molecular composition of fifteen polypeptide synthesizing enzymes, transphosphorylases and decarboxylases, their absence produces general chlorosis in plants, as well as intense defoliation. Sulfur stimulates growth and nitrogen absorption, as well as formation of plant defense substances, along with boron gives flexibility to tissues.

Iron plays an important role as catalyst for reactions of chlorophyll synthesis because it functions as an oxygen carrier and its deficiency causes chlorosis in plants leaves; besides being an essential element for practically all living beings fulfilling important cellular functions like synthesis of DNA, respiration and detoxification of free radicals. Zinc is necessary for the synthesis of substances responsible for plants growth as well as enzymatic systems such as dehydrogenases, proteinases and peptidases. The main function of Manganese is to be part of a system of plant enzymes. Copper is necessary in chlorophyll formation and catalyzes several reactions in the plant. Boron helps in roots and main stems formation, and in addition to magnesium, iron and copper increases the plants support and strength against diseases.

Not only having nutrients and micronutrients is sufficient, it is also necessary supply them in an adequate proportion so that they can have a proper assimilation. For these reasons it is known that use of fertilizers containing nutrients and micronutrients in adequate proportions is indispensable in soils lacking any of them.

In nature, iron (Fe) is found mainly as Fe³⁺ forming salts and hydroxides of very low solubility, chemical forms that preclude their use by some living beings. The availability of this element is fundamental either in success or failure of pathogenic and symbiotic microorganisms to invade an organism or to colonize a given environment. To solve this problem, many organisms including bacteria, fungi and plants, produce small molecules of high affinity to iron called siderophores, that act specifically as chelating agents to sequester iron in presence of other metals and to reduce it to Fe²⁺, a form much more soluble and usable for their nutrition. Bacterial siderophores have aroused great interest in recent years due to the potential they have to biological control of phytopathogenic fungi and bacteria and for constituting a mechanism which increases development of plant growth promoting rhizobacteria. Analogues of these molecules in plants, known as phytosiderophores, also play a fundamental role in iron assimilation by plants. The importance of phytosiderophores has been strengthened because of the increase in salinity of irrigation water and thus the pH of soils, resulting from the reduction of aquifers that leads to a reduction of iron availability.

Next is a description of some documents that refer to siderophores or siderophores producers, in compositions or inoculants and their use.

CN103087960 relates to an antimicrobial inoculant formulated with Bacillus amyloliquefaciens FQS38 characterized to carry out colonization of tomato roots, to promote its growth and to contribute in prevention and treatment of diseases. In addition, the antibiotic inoculant can secrete proteases, cellulase, siderophores, auxins, gibberellins and other antibacterial and growth promoting ingredients. This document does not affect the novelty and inventive step of the present invention, since the main components used are different being a bacterial inoculant alone.

In Document CN 102796684, the invention provides a promoter of alfalfa growth based on the rhizobacteria MJM-11 and its application thereof. It is a strain of Enterobacter ludwigii MJM-11 that can be applied in four different ways including preparation of siderophores and promoting plants growth under saline-alkaline stress. This document does not affect novelty and inventive of the present invention since the main components used are different being a bacterial inoculant alone.

US 2011268818 relates to a compositions comprising a NGAL lipocalin, and a mammalian siderophore which are useful as chelants and iron donors. The invention also provides mammalian siderophore compounds, besides methods of treatment and diagnostic methods. This document does not affect the novelty and inventive step of the present invention since the siderophores mentioned herein are of mammalian origin and used for treatment and diagnosis of iron deficiency in mammals.

U.S. Pat. No. 4,872,899 relates to a method and composition for treatment of iron deficiency chlorosis in plants by the use of siderophores of the hydroxamic acid type. Siderophores of this type are specific ferric chelators produced by certain microorganisms grown in iron-free environments. The siderophore can be applied to the plant through a variety of methods, including application in soil, foliar spraying or direct injection. This document does not affect the novelty and inventive step of the present invention since the present invention relates to a composition supported by mineral clays added with siderophores, secondary nutrients and micronutrients.

WO/2012/130221 relates to a long-acting agent against phytopathogenic microorganisms, especially fungi which is prepared on the basis of Bacillus amyloliquefaciens plantarum spores. Representatives of this taxonomic group have the capacity to produce at least ten different antimicrobial substances belonging to families of dipeptides, lipopeptides and siderophores, polyketides and the group consisting of bacteriocins/microcines. This Document does not affect the novelty and inventive step of the present invention since it again refers to an inoculum or agent based on a siderophore-producing microorganism which is also used to control phytopathogenic agents and not as a component in a nutrient mixture or a Nutrient in itself.

None of the foregoing Documents nor those found in databases affect the novelty and inventive step of the present invention, since the majority of these relate to the use of a siderophore-producing microorganism as an inoculant and for use against specific diseases of plants or crops or for use in diseases in some animals, but not the use or application of siderophores and/or additional components to nutrition of agricultural crops.

The present invention describes the development of a solid granular fertilizer containing siderophores, micronutrients and secondary nutrients in suitable proportions, according to the needs of each type of soil, the combinations of siderophores, micronutrients and secondary nutrients to formulate the fertilizer all supported by a material with a high CIC (clay), results in a granulated fertilizer of controlled solubility and also allows a simple, metered and efficient application of nutrients and micronutrients at low cost.

### DESCRIPTION OF INVENTION

The present invention consists in a fertilizer composition based on mineral clays to which micronutrients and secondary nutrients are added, besides the addition of Siderophores for nutrition of agronomic crops, where Siderophores are iron chelating agents capable of sequestering it in presence of other metals and reducing it from its Fe³⁺ to Fe²⁺ form, a much more soluble and usable form.

In a first modality the composition of the present invention for agronomic crops nutrition comprises:
A) Iron,
B) Zinc,
C) Manganese,
D) Boron,
E) Copper,
F) Molybdenum,
G) Sulfur,
H) Calcium,
I) Magnesium,
(J) Siderophores and,
K) Mineral clays.

In a modality the composition of the present invention for agronomic crops nutrition comprises:
A) Iron 5 to 30%,
B) Zinc 1 to 20%,
C) Manganese 0.1 to 10%
D) 1 to 10% boron,
E) Copper 0.1 to 10%
F) 0.1 to 10% molybdenum,
G) Sulfur 1 to 10%,
H) Calcium 1 to 10%,
I) Magnesium 1 to 10%
(J) Siderophores 1 to 50% and
K) Mineral clays 30 to 60%.

All this must be combined within the ranges mentioned so that it totalize 100%.

The percentages are based on total weight of the fertilizer where iron is presented as Ferrous Sulfate Monohydrate, Zinc as Zinc Sulfate Monohydrate, Copper as Copper Sulphate Pentahydrate, Manganese as a Manganese Sulphate, Sulfur as Elemental Sulfur and calcium as Calcium Sulfate.

In the present invention the mineral clay may be a mixture of kaolinite, smectite (montmorillonite), mica, hematite, talc, and orthoclase clays.

The siderophores in the present invention may be catechols, hydroxamates, α-hydroxy carboxylates, mixed and/or a combination thereof.

The siderophores in the present invention can be obtained through microbial synthesis (products of bacteria, fungi and/or yeasts), or through chemical synthesis.

The product presentation of the present invention is a granulated form from 2.3 to 4.0 millimeters, size appropriate to be used either mixed with other fertilizers or individually. It has a hardness between 1.9 and 2.3 kg/cm², sufficient to withstand the subsequent handling, while it prepares and mixes with other nutrients. The preparation conditions make the material able to support handling during manipulation. When mixed with other nutrients it has low degradation to powder and also has the capacity to be 100% soluble, a characteristic that allows it to reach plants roots.

### Generalities of the Siderophores

Siderophores act as iron solubilizing agents from mineral or organic compounds such as lactoferrin and transferrin in vertebrates. Most are low molecular weight peptides produced by microorganisms. Siderophores are synthesized and secreted into the extracellular medium, where they bind to iron and are recovered by specific transporters. In Gram negative bacteria this process is performed by an external membrane receptor coupled to an ABC-type transporter. Once in the cytoplasm the iron must be released from the iron-siderophore complex, a process carried out by enzymatic degradation of the complex or by iron reduction.

Due to its reactivity, iron is sequestered in various proteins of organisms such as transferrin, lactoferrins and ferritins. The first two found extracellularly (in organisms fluids), while ferritins are part of the intracellular iron storage proteins. Ferritins are the primary iron storage compounds for most organisms and are found in animals, plants (phytoferritins) and microorganisms (bacterioferritins). Bacterioferritins are found in both bacteria and fungi and differ from animal and plant ferritins in that they have a bound heme group. In all these organisms ferritins fulfill similar functions as sources of iron storage when cells grow in iron abundance, reserves used when drop the levels of this.

When a microorganism enters a host organism, whether in pathogenic or symbiotic form, it finds a favorable environment to access practically to all necessary nutrients for growth, except iron. Iron, unlike other elementary sources for nutrition, such as nitrogen, phosphorus, potassium and other macro and micronutrients, is not freely available in host organisms, and therefore constitutes an important limiting factor for microorganisms growth. It is known that a response of host organisms to pathogen attack is reduction of free iron by sequestration the metal in ferritin molecules. This mechanism operates in both animals and plants, although a notable difference is that in the former the control of ferritin synthesis occurs at the translational level, whereas in plants it occurs at the transcriptional level.

Microorganisms that inhabit a host organism either in pathogenic or symbiotic form, may use iron of the organism that hosts them, either extracellularly from the transferrin, lactoferrins or ferric hydroxides, or intracellularly from hemoglobin or ferritins.

Microbial siderophores are molecules secreted by microorganisms under iron deficiency conditions to sequester iron from their environment. Siderophores are low molecular weight molecules from 0.5 to 1.0 kDa, soluble in aqueous solutions at neutral pH that are synthesized by bacteria, mainly gram negative, fungi, yeasts and some plants (phytosiderophores), particularly grasses and that act as specific chelating agents of Fe³⁺. The main characteristic of this type of molecules is that they have a high iron dissociation constant, which ranges from 1022 to 1055. Synthesis of these molecules increases when microorganisms are in iron-limiting conditions. The high affinity of these molecules for iron facilitates uptake of this metal from compounds such as ferric hydroxide and proteins from host organism such as transferrin or ferritin.

Complexes tha siderophores form with iron in soils, are assimilated efficiently so much by the microorganism that produces them as by other microorganisms they inhabit around. It is precisely through the synthesis of siderophores that some bacteria living in soil positively influence the growth of plants.

### Types of Siderophores

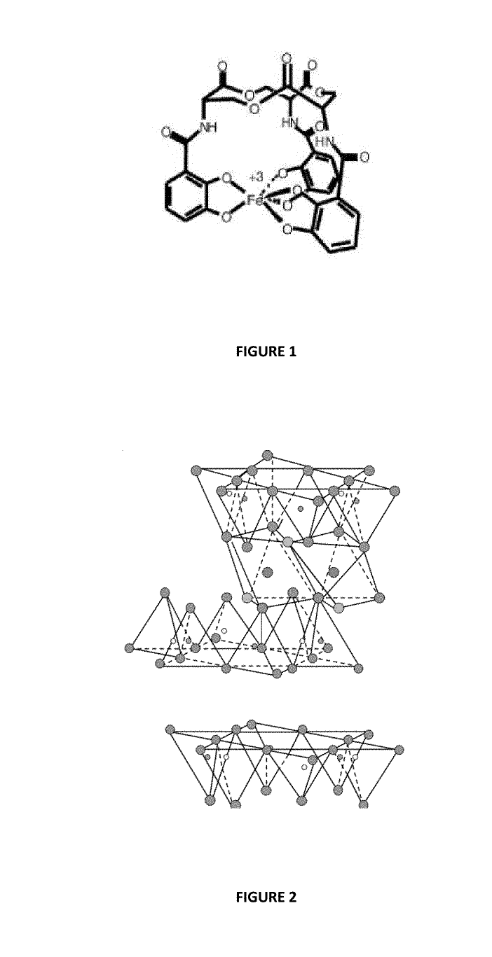

Most siderophores forms a hexadentate bonding center, since their chemical structure usually consists of three double ligands arranged around a central ferric ion (FIG. 1). Hexadentate siderophores forms 1:1 complexes with ferric ions, such that release of the ion is unlikely, thus decreasing its potential toxicity. Iron-binding groups are included in a larger chemical structure that maximizes their efficiency. Depending on the nature of the group mediating the union with iron atom, siderophores can be divided into three basic types: catechol, hydroxamates and α-hydroxycarboxylates, although mixed-type siderophores have been described having in their structure various types of bonding groups.

### Synthesis of Siderophores

More than 500 different siderophores have been described. Most are of peptidic nature and are synthesized by endogenous enzymes of the non-ribosomal peptide-synthetase (NRPS) family. Siderophores which are not polypeptides, are dicarboxylic acids, diamines or amino alcohols, and are synthesized by specific synthetases in what is known as NRPS Independent Synthesis. In recent years new routes and new components have been described, so that the biosynthetic enzymology of many siderophores is known in detail.

### Overview of Clays

Clays comprise a group of minerals (clay minerals), most of which are phyllosilicates, whose physicochemical properties depend on their structure and grain size, which is very fine (less than 2 μm). Clays have a structure based on the stacking of oxygen ions planes and hydroxyl ions. The tetrahedral groups (SiO)₄⁴⁻ are united by sharing three of their four oxygens with another neighbors forming layers of infinite extension and formula (Si₂O₅)²⁻, which constitute the fundamental unit of phyllosilicates. In them, tetrahedrons are distributed into hexagons. Tetrahedral silicon can be partly replaced by Al³⁺ or Fe³⁺.

These tetrahedral layers are joined to another octahedral gibbite or brucite type layers, where some Al³⁺ or Mg²⁺ may be substituted by Fe²⁺ or Fe³⁺ and more rarely by Li, Mn, Ni, Cu or Zn. The union plane between the two layers is formed by the oxygen molecules of the tetrahedra which were not shared with other tetrahedra (apical oxygens) and (OH)⁻ groups of the brucitic or gibsitic layer, so that in this plane, an (OH)⁻ remains in the center of each hexagon formed by 6 apical oxygens. The rest of (OH)⁻ groups are replaced by the oxygens of the tetrahedra as in FIG. 2, where the blue circles are Oxygen atoms, the pink circles are Hydroxyl ions, the orange circles are Aluminum, Iron or Magnesium ions and the Green and yellow circles correspond to Silicon, and occasionally aluminum.

A similar bond may occur on the opposite surface of the octahedral layer. Thus phyllosilicates can be formed by two layers: tetrahedral plus octahedral layers, which are called bilaminars, or by three layers: one octahedral and two tetrahedral, so called trilaminars. A unit formed by the union of an octahedral layer plus one or two tetrahedral layers is called a sheet.

If all octahedral holes are occupied, the sheet is called trioctahedral (Mg²⁺ dominant on the octahedral layer). If only two-thirds of the octahedral positions are occupied and the remaining third is vacant, it is called dioctahedral (being Al³⁺ the dominant cation).

In some phyllosilicates (smectites, vermiculites, micas, etc.), the sheets are not electrically neutral due to substitutions of some cations by others of different charge. Charge balance is maintained by the presence of cations (such as in the group of micas), hydrated cations (as in vermiculites and smectites) or hydroxyl groups Coordinated octahedral, similar to octahedral layers, as in the chlorites; placed in the interlaminar space or the space between two consecutive sheets. The unit formed by a sheet plus the interlayer is the structural unit. The most frequent interlaminar cations are alkaline (Na and K) or alkaline earth (Mg and Ca).

The forces that bind the different structural units are weaker than those between the ions of the same sheet, so the phyllosilicates have a clear exfoliation direction parallel to the sheets.

### Physicochemical Properties of Clays

The physicochemical properties are mainly derived from: its extremely small particle size (less than 2 μm), its laminar morphology (phyllosilicates), the isomorphic substitutions, leading to the appearance of charge on the sheets and to the presence of weakly bound cations in the interlaminar space.

As a consequence of these factors, they have, on the one hand, a high value of the surface area and, at the same time, the presence of a large amount of active surface, with unsaturated bonds. Therefore they can interact with many different substances, especially polar compounds, so they have plastic behavior in clay-water mixtures with a high solid/liquid ratio.

On the other hand, the existence of charge in the sheets is compensated, as already mentioned, with the entry into the interlaminar space of weakly bound cations and with a variable hydration state, which can be easily exchanged by contacting the Clay with a solution saturated with other cations, this property is known as cation exchange capacity which is also the basis for the application in the formulation of the granular fertilizer.

### Specific Surface Area

The specific surface or surface area of a clay is defined as the area of the outer surface plus the area of the inner surface (if any) of the constituent particles, per unit mass, expressed in m2/g. The clays have a high specific surface, very important for certain industrial uses in which the solid-fluid interaction depends directly on this property.
High crystalline kaolinite up to 15 m²/g
Low crystalline kaolinite up to 50 m²/g
Halloisite up to 60 m²/g
Ilite up to 50 m²/g
Montmorillonite 80-300 m²/g
Sepiolite 100-240 m²/g
Paligorskite 100-200 m²/g

### Cation Exchange Capacity

It is a fundamental property of smectites to easily exchange the ions fixed on the outer surface of their crystals, in the interlaminar spaces or in other interior spaces of the structures; by others existing in the surrounding aqueous solutions. Cation exchange capacity (CEC) can be defined as the sum of all exchangeable cations that a mineral can adsorb at a given pH. It is equivalent to the amount of total negative charges of the mineral. These negative charges can be generated in three different ways:
Isomorphic substitutions within the structure
Unsaturated bonds on outer edges and surfaces
Dissociation of accessible hydroxyl groups.
The first type is known as permanent carte and accounts for 80% of the net charge of the particle; besides it is independent of the conditions of pH and ionic activity of the medium. The last two types of origin vary depending on pH and ionic activity. They correspond to crystalline edges, chemically active and represent 20% of the total charge of the sheet.

### Advantages

As a main advantage, the siderophores present in the composition of the present invention act as an iron chelating agent (Fe) capable of sequestering it in the presence of other metals and reducing it from its Fe³⁺ to Fe²⁺ form, a much more soluble and usable form for plant nutrition.

In the present invention, clays such as kaolinite, smectite (montmorillonite), mica, hematite, talc and/or orthoclase are used as carrier material, which, thanks to their fillers, tend to bind together by being wetted. The agglomeration process (or granulation) is carried out in a pelletizing dish.

Over application of the fertilizer, dissociation of cations takes place, which due to the load of clays are adsorbed. It is necessary to emphasize that clays have a cation exchange capacity of 10 to 200 me/100 g as previously seen due to their negative charges. This helps the same clay to retain Fe⁺⁺, Zn⁺⁺, Mn⁺⁺ and Cu⁺⁺ cations and to be exchanged for H⁺ cations found on the root surface of the plant. Because of this, the mixture of materials becomes a highly assimilable fertilizer.

It is important to emphasize that although clay mixed with zinc, manganese, copper and ferrous sulfates have a high agglomeration capacity, the use of an agglutinant such as calcium hydroxide is essential to give the granule a higher hardness between 1.9 and 2.3 kg/cm², and ensure that it is not going to grinded up at the time of mixing with other fertilizers, thus facilitating their application. The fertilizer has a low moisture content (2 to 6%) which allows it to be mixed with hygroscopic fertilizers such as urea, even in a ratio of 1:1 without problems that may affect its physical characteristics.

Another advantage of the product developed is that thanks to the progressive dissolution of its components allows it to act during most of the crop cycle; Ie on contact with water the components gradually dissolve.

### EXAMPLES

The following examples are intended to illustrate the invention, not to limit it. Any variation by those skilled in the art falls within the scope thereof.

### Example 1

To produce one tonne of granulated fertilizer, 100 kg of ferrous sulfate monohydrate, 200 kg of zinc sulphate monohydrate, 28 kg of copper sulphate heptahydrate, 5 kg of manganese sulphate monohydrate, 1 kg of calcium hydroxide, 500 kg of Siderophores and 164 kg of pulverized clay until a homogeneous mixture was obtained. The mixture is emptied in a pelletising dish at a flow rate of 17 kg/min. The dish has a diameter of 1.8 m, with an inclination angle of 37° and rotates at 38 rpm, the mixture in the dish is sprayed with water at a flow of 1.25 lt/min. The granules formed are fed to a rotary kiln of 3 sections, heated by a burner which is fed with a mixture of hydrocarbons predominating methane. Inside the oven reaches a temperature of 100° C. in the first section, which decreases to 57° C. in the last section, to obtain a final moisture of the product around 3%. The fertilizer granules are then screened through the opening mesh 2.3 (mesh 8) and 4.0 mm (mesh 5).

The product that passes through the 5 mesh and is retained in the 8 mesh corresponds to a product of 2.3 to 4.0 millimeters in diameter that will be ready to be packaged and dispensed. The smaller granules that pass through the mesh 8 are fed back to the mixer and reprocessed. Larger granules are triturated and reprocessed by feeding them back into the mixer.

The obtained granulated fertilizer can be applied of 20-40 kg/Ha in vegetables and grasses and 100-200 gr/tree in case of fruit trees. In soils where established crops are found with low fertility levels and alkaline pH.

### Example 2

To produce one tonne of the granulated fertilizer, 150 kg of ferrous sulfate monohydrate, 29 kg of zinc sulphate monohydrate, 24 kg of copper sulphate pentahydrate, 42 kg of manganese sulphate, 54 kg of magnesium oxide, 132 kg of sulphate Of calcium, 89 kg of sulfur, 2 kg of calcium hydroxide, 1 kg of siderophores and 477 kg of pulverized clays are mixed until a homogeneous mixture is obtained. The mixture is emptied in a pelletizing dish at a flow of 12.5 kg/min. The dish has a diameter of 1.8 m, with an inclination angle of 37° and rotates at 38 rpm, the mixture in the dish is wetted with a water and calcium hydroxide mixture in 1.25 lt/min flux. The granules formed are fed to a rotary kiln of 3 sections heated by a burner which is fed with a mixture of hydrocarbons predominating methane. Inside the oven reaches a temperature of 100° C. in the first section, which decreases to 57° C. in the last section, to obtain a final moisture of the product around 3%. The fertilizer granules are then screened through the opening mesh 2.3 (mesh 8) and 4.0 mm (mesh 5).

The product that passes the 5 mesh and is retained in the 8 mesh is a product of 2.3 to 4.0 millimeters in diameter that will be ready to be packed and distributed. The smaller granules that pass the 8 mesh are fed back to the mixer and reprocessed. Larger granules are triturated and reprocessed by feeding them back into the mixer.

The obtained granulated fertilizer can be applied 20-40 kg/Ha in vegetables and grasses and 200-400 gr/tree in case of fruit trees. In soils where established crops are found with low fertility levels and alkaline pH.

1. A fertilizer composition for crop nutrition comprising mineral clays, micronutrients, secondary nutrients, and Siderophores.

2. The fertilizer composition according to claim 1,
A) Iron;
B) Zinc;
C) Manganese;
D) Boron;
E) Copper;
F) Molybdenum;
G) Sulfur;
H) Calcium;
I) Magnesium;
(J) Siderophores; and
K) Mineral clays.

3. The fertilizer composition according to claim 1, comprising:
A) Iron 5 to 30%;
B) Zinc 1 to 20%;
C) Manganese 0.1 to 10%;
D) 1 to 10% boron;
E) Copper 0.1 to 10%;
F) 0.1 to 10% molybdenum;
G) Sulfur 1 to 10%;
H) Calcium 1 to 10%;
I) Magnesium 1 to 10%;
(J) Siderophores 1 to 50%; and
K) Mineral clays 30 to 60%.

4. The fertilizer composition according to claim 3, wherein weight percentages are based on total weight of the fertilizer where iron is presented as Ferrous Sulfate Monohydrate, zinc as Zinc Sulfate Monohydrate, copper as Copper Sulphate Pentahydrate, Manganese as Manganese Sulphate, sulfur as elemental Sulfur, and calcium as Calcium Sulfate.

5. The fertilizer composition according to claim 1, wherein the mineral clays are a mixture of kaolinite, smectite (montmorillonite), mica, hematite, talc and orthoclase clays.

6. The fertilizer composition according to claim 1, wherein the siderophores are one or more of catechol, hydroxamates, α-hydroxy carboxylates, and combinations thereof.

7. The fertilizer composition according to claim 1, wherein the siderophores are obtained through microbial synthesis or through chemical synthesis.

8. The fertilizer composition according to claim 1, wherein the Siderophores are iron chelating agents capable of sequestering iron in presence of other metals and reducing iron from its Fe³⁺ to Fe²⁺ form.

9. The fertilizer composition according to claim 1, wherein the fertilizer is granulated from 2.3 to 4.0 millimeters.

10. The fertilizer composition according to claim 1, wherein the conditions of preparation make the material capable of supporting handling during manipulation.

11. The fertilizer composition according to claim 1, wherein the mineral clays, when mixed with other nutrients, have a low degradation to powder and also have the capacity to be 100% soluble.

12. The fertilizer composition according to claim 1, wherein the fertilizer has a hardness between 1.9 and 2.3 kg/cm².
